(19) United States
(12) Patent Application Publication
(10) Pub. No.: US 2026/0339961 A1
(43) Pub. Date: Oct. 29, 2026

(54) APPARATUS AND METHOD FOR BUILDING A RICH CONTEXTUAL USER STORE TO AUGMENT QUERY PROCESSING

(71) Applicant: Sunshine AI, Inc., Palo Alto, CA (US)

(72) Inventors: Marissa MAYER, San Francisco, CA (US); Hemanth SUNKARA, Los Altos, CA (US); Vishal RAITHATHA, Santa Clara, CA (US); Mahendra KUMAR, Mountain View, CA (US)

(21) Appl. No.: 19/202,454

(22) Filed: May 8, 2025

Related U.S. Application Data
(60) Provisional application No. 63/793,093, filed on Apr. 23, 2025.

(51) Int. Cl. G06F 16/2457; G06F 16/9535

(52) U.S. Cl. CPC G06F 16/24575; G06F 16/9535

(57) ABSTRACT

A server uses a network connection to access user media (photos and videos) on a client machine. Metadata of the user media is formed, such as timestamp, geographic location, and camera specification (make, model, lens info). Image analysis and computer vision techniques analyze and extract features such as number of faces, location of faces (bounding boxes), face embeddings, classification of people, animals, places and objects. The metadata and features combined produce a rich store which is then summarized into a contextual profile about the user. The store and profile are used as context supplied to large language models (LLMs) to answer a wide variety of insightful and personalized questions. The output of the large language model is delivered to a specialized media task performer that executes various actions. This enables users to gain meaningful insights from their media in response to natural language interactions.

### CROSS REFERENCE TO RELATED APPLICATION

This application claims priority to U.S. Provisional Patent Application 63/793,093, filed Apr. 23, 2025, the contents of which are incorporated herein by reference.

### FIELD OF THE INVENTION

This invention relates generally to query processing in computer networks. More particularly, the invention is directed to building a rich contextual user store to augment query processing.

### BACKGROUND OF THE INVENTION

In recent years, the volume of digital media created and stored by individuals has grown exponentially, with users accumulating thousands of photos and videos across various devices and platforms. While this media contains a wealth of information about users' experiences, interests, and personal history, traditional methods of organizing and interacting with this data have remained relatively rudimentary, typically limited to basic categorization by date, location, or manual tagging.

Existing solutions for media management and analysis typically rely on isolated approaches that fail to build comprehensive user profiles that can inform intelligent interactions. Photo management applications offer basic organization and search capabilities but lack the ability to leverage deep contextual understanding for answering complex questions or performing sophisticated tasks. Similarly, voice assistants and AI interfaces, while advancing in natural language processing capabilities, have limited ability to access and utilize personal media archives as a knowledge base for personalized assistance.

Furthermore, current systems often require explicit commands or specific query formats, limiting their utility for users seeking natural conversational interactions. The disconnect between abundant personal media data and intelligent systems capable of leveraging this information creates a significant gap in providing truly personalized and insightful digital assistance.

### SUMMARY

A server with a processor executes instructions to access user media via a network connection to a client machine. The user media is analyzed to develop a user profile. A contextual store of user profiles is formed. A query and user profile information is sent to a network connected machine hosting a large language model. A query response is sent to the client machine.

### BRIEF DESCRIPTION OF THE DRAWINGS

The invention is more fully appreciated in connection with the following detailed description taken in conjunction with the accompanying drawings, in which:

FIG. 1 illustrates a system configured in accordance with an embodiment of the invention.

FIG. 2 illustrates processing operations performed in accordance with an embodiment of the invention.

Like reference numerals refer to corresponding parts throughout the several views of the drawings.

### DETAILED DESCRIPTION

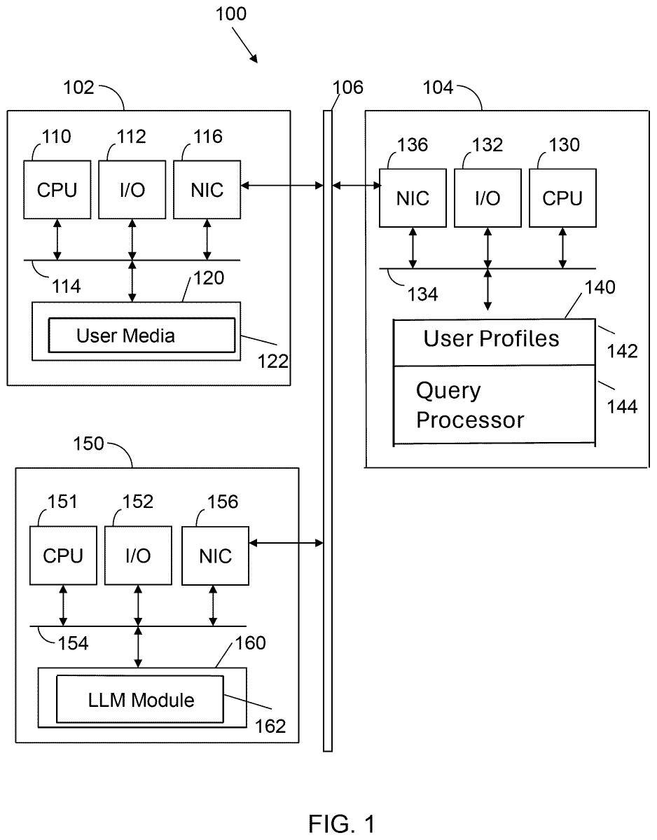

FIG. 1 illustrates a system 100 configured in accordance with an embodiment of the invention. System 100 includes a client device 102 in communication with a server 104 via a network 106, which may be any combination of wired and wireless networks. Client machine 102 includes a processor 110 in communication with input/output devices 112 via a bus 114. A network interface circuit 116 is connected to bus 114; the network interface circuit 116 provides access to network 106. A memory 120 is connected to bus 114. The memory 120 stores user media 122.

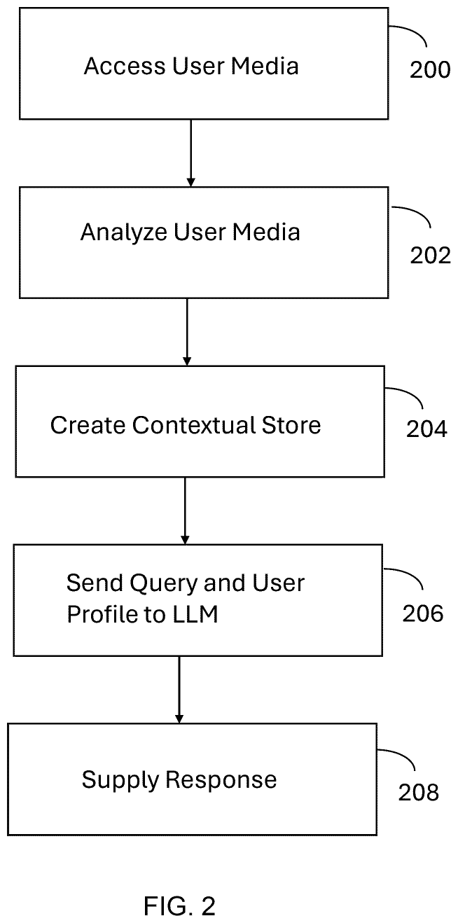

Server 104 includes a processor 130, input/output devices 132, a bus 134 and a network interface circuit 136. A memory 140 is connected to bus 134. The memory 140 stores user profiles 142 and a query processor 144. Server 104 implements the operations of FIG. 2. Server 104 also interacts with a Large Language Model computer 150.

Large language model computer 150 includes a processor 151, input/output devices 152, bus 154, and network interface circuit 156. A memory 160 is connected to bus 154. The memory 160 stores a large language module 162 with instructions executed by processor 151.

The first operation of FIG. 2 is to access user media 200. Server 104 establishes secure access to a user's photo and video collections (user media 122) across devices and platforms, implementing appropriate privacy controls and permissions. It then systematically extracts comprehensive metadata from each media item, including temporal information, geolocation data, device specifications, orientation, and other technical attributes.

Next, the user media is analyzed 202. Advanced computer vision and machine learning algorithms analyze the media content to identify and classify entities such as people, animals, places, and objects. The system extracts detailed features including face locations with bounding boxes, face embeddings for identity recognition, object classification, scene understanding, and aesthetic quality assessment from each media item. Such features are stored in their raw form against each media item corresponding to a user.

The system processes these extracted features to create a dynamic and rich contextual store 204. The contextual store is a comprehensive database that accumulates all extracted metadata and features from every piece of accessible media. This store serves as the foundation of the system and grows continuously as new media is added and analyzed, creating an increasingly detailed record of user's activities, experiences, interests, preferences, habits, personal history, interactions, and identity. Rather than merely storing discrete data points, the system employs sophisticated algorithms to identify patterns, preferences, significant events, relationships, and behaviors. This store evolves continuously as new media is added, maintaining a comprehensive and current understanding of the user's life context.

For example, face identities are established by calculating similarities between face embeddings across various media items and canonicalizing a set of face embeddings to a person. Once the face identities are established in such a store, relationships between entities emerge by calculating frequencies to identify recurring patterns and contextual significance. This information can be used to identify relationships between different sets of entities.

### Family Relationships

Family relationships can be identified by looking at recurring patterns between different people in family-specific contexts.

Example: The system identifies that Person A (David) and Person B (Sarah) frequently appear together in photos spanning 15+ years with consistent proximity. They often appear with younger Persons C and D (Emma and Jacob) in settings like holiday gatherings, vacations, and home environments. Based on age differences, physical similarities, and contextual clues (birthday celebrations, graduation photos), the system determines David and Sarah are likely parents to Emma and Jacob.

### Friendship Relationships

Friendship relationships can be detected through regular social interactions in recreational contexts.

Example: Person E (Michael) and Person F (Jennifer) appear together frequently in social settings such as restaurants, concerts, and casual gatherings, but not in family holiday photos or formal family portraits. Their appearance together spans approximately 3 years with no consistent pattern of physical intimacy that would suggest a romantic relationship. The system identifies them as friends based on their recurring co-presence in social but non-family, non-professional contexts.

### Interest Relationships

Interest relationships can be established by looking at recurring patterns of a person performing certain activities.

Example: Person G (Thomas) appears in numerous photos with mountain biking equipment across various outdoor trails and biking events. The system detects his presence with biking gear in 37 different locations over a 2-year period. Despite changing weather conditions, companions, or specific bicycles, Thomas consistently engages in this activity. The system establishes “mountain biking” as a significant interest for Thomas based on frequency, duration, and emotional expressions captured in these contexts.

### Ownership Relationships

Ownership relationships can be established by measuring recurring connections between a person and specific items.

Example: Person H (Rachel) appears with a distinctive blue Tesla Model 3 in 85% of photos where vehicles are present. The system detects this specific vehicle in Rachel's driveway, at her workplace, and during road trips. The consistent presence of this vehicle exclusively with Rachel (and occasionally her known family members) over an 18-month period establishes an ownership relationship between Rachel and this particular car.

### Pet Relationships

Pet relationships can be identified through recurring appearances with specific animals.

Example: Person I (Daniel) appears with a golden retriever in numerous home settings, walks, and outdoor activities. The system identifies consistent care behaviors (feeding, walking, playing) and the dog's presence in approximately 60% of Daniel's photos over a 4-year period. Based on this pattern and the absence of the same dog with other primary individuals, the system establishes Daniel as the owner of this golden retriever.

This framework systematically identifies social connections, interests, and possessions by analyzing patterns of co-occurrence, contextual settings, and temporal consistency across visual data without requiring explicit relationship labels.

Building upon this rich store, the system employs sophisticated algorithms to generate a separate contextual profile about the user. This profile is a summarized, structured representation derived from analyzing patterns within the rich contextual store. The contextual profile identifies preferences, significant events, relationships, recurring locations, behaviors, and other meaningful insights. Unlike the comprehensive but raw data in the rich store, the contextual profile represents processed, relevant information optimized for quick access by language models.

For example, in a user's camera roll one will find many media items that have repeated faces along with repeated common household items like a television, a dining table, couches etc. at the same location. Consequently, one can predict that there is a high likelihood that the location is a home.

Similarly, if there are recurring patterns in photos of juveniles (identified by faces) playing water polo over the week/weekends then there is a high likelihood that the user's kids participate in water polo. Such summarized information can be very helpful in providing relevant answers to questions.

As the rich store grows over time with the addition of new media and metadata, the contextual profile is dynamically updated to become increasingly detailed and accurate. This dual-component approach allows the system to maintain both comprehensive raw data (the store) and an optimized representation (the profile) simultaneously.

The user profiles 142 in the contextual store augment query processor 144. The next operation of FIG. 2 is to send a query and user profile to an LLM. For example, server 104 receives a query from user machine 102. The server 104 sends the query and profile to machine 150 via network 106. The response is received at server 104 and is sent to the client machine 102.

The contextual profile provides the LLM module 162 with personalized context that enables the LLM module 162 to answer complex, nuanced questions about the user's media and experiences. Unlike generic AI assistants, this system can respond to queries with a far more personalized response. For example, a query like “What should I do over the weekend?” made in San Diego can propose a kayak ride in La Jolla. This is because (from the above examples) the system knows that the user engages in adventure sport activities like kayaking, and it also knows that the user is in San Diego. The prompt formed for LLM will include the user's interests from the profile and then the actual question asked by the user. This relevant context in the prompt allows the LLM response to be far more personalized.

Similarly, responses to queries like “Where should I take my kids this weekend?” can be far more relevant when a rich profile that has information about their interests is accessible and provided as context in the prompt. The detailed attributes serve as an expansive illustration of what kinds of information the system can infer and catalog. Embodiments of the invention develop contextual information, such as:
Demographics and Identity
   Age (approximate, based on appearance)
   Gender presentation
   Ethnicity or cultural
   background Style and aesthetic
   preferences
Personality and Interests
   Hobbies and activities (sports, cooking, travel, music, etc.)
   Extroversion vs. introversion (group shots vs. solo, public vs. private settings) Risk tolerance (adventure photos, stunts, etc.)
   Creativity (photo composition, filters, unique perspectives) Lifestyle and Values
   Travel habits (frequency, types of destinations) Career clues (badges, workspaces, uniforms, conferences) Social life (friends, frequency of group settings, events) Family dynamics (relationships, presence of kids, partners, elders)
Environment and Status
   Home decor/space (can hint at socioeconomic status or taste) Clothing brands/accessories (status symbols, style cues) Technology use (devices, photography equipment)
   Location context (city life, rural, international) Patterns Over Time
   Life events (weddings, graduations, babies)
   Health and wellness (changes in physique, visible habits) Seasonality (outfits, weather, holidays celebrated) Consistency or change (loyal to a look vs. experimental)
Psychological/Emotional Clues
   Facial expressions (mood trends, confidence, anxiety)
   Body language (openness, shyness, dominance)
   Presence vs. absence in photos (self-presentation tendencies)

Finally, the system includes a specialized task performer component that can execute complex media-related actions based on natural language requests, such as creating albums, editing photos according to user preferences, sharing media with specific contacts, or creating personalized content summaries. Such a system can respond to user provided tasks like “Make a photo collage for my dog” or “Make a photo book with relevant captions from the London Trip with my family” efficiently.

The invention represents a significant advancement in personalizing AI assistance by leveraging the rich information contained in users' media collections, enabling more natural, insightful, and helpful interactions while maintaining appropriate privacy safeguards and user control.

### EXAMPLES

This section describes some of the questions users can ask or requests that the users can make on an interface that this invention exposes and the corresponding response from the system. Note that the input to the system is in a user's natural language and output from the system is a combination of natural language response, a set of photos that are shown to the user and a set of actions that the user is requesting the system to take.

Example 1:
User: “Where should I go on a hike this weekend?”
System: Analyzes all the past photos where the user has been on a hike, looks at its
locations, key characteristics of the hike/trek like did it involve streams and water,
rocky mountains, guided trails or rough terrain and based on all of this information
comes up with a suggestion.
System output: “Based on your previous hiking experiences I'd recommend going on a
hike to Rancho San Antonio's Wildcat loop trail. It's a moderate 3 mile hike with scenic
views. Would you like a different recommendation?”

Example 2:
User: “What present should I buy my nephew for his birthday?”
System: [ System analyzes all photos of Alex through facial recognition and identifies
his interests and activities. It detects objects he frequently interacts with and appears
to enjoy based on facial expressions and engagement levels. The system looks for
items he already owns or shows affinity toward, noting their condition and age. It
identifies recurring locations and contexts to establish preference patterns. ]
System output: “[ Based on your photos from the last few soccer games you attended
with Alex, I can see he's really passionate about the sport. The photos from March
show him wearing a Manchester United jersey that appears to be getting a bit small for
him. He also seems to enjoy outdoor activities - I notice several camping trips where he
appears enthusiastic about setting up equipment. Since his birthday is in June (based
on last year's birthday photos), a new Manchester United jersey in the next size up or
quality camping gear appropriate for summer would likely be appreciated. ]”

Example 3:
User: “What are some ideas for a short trip during the spring break?”
System: Analyzes past photos from short trips and vacations and identifies user's
preferences on the kind of vacations that they have been on.
System output:
Based on your past trip to Oregon and Puerto Vallarta it looks like you enjoy a mix of
beach destinations and natural environments. This combination suggests you might
appreciate destinations that offer both coastal relaxation and opportunities to explore
diverse ecosystems or outdoor activities.
Some destinations that might appeal to your travel preferences include:
Costa Rica, with its beautiful beaches and incredible rainforests
New Zealand, offering both coastal beauty and stunning inland landscapes
Hawaii, where you can find tropical beaches alongside volcanic landscapes

Example 4:
User: Create a photo book of my London trip
System: Finds the best photos of the London trip, uses a mix with all the people in the
trip, analyzes each photo and adds a relevant caption to each photo and prepares and
presents a photo book that can be commercially printed.
System output: Looks like you had an excellent London trip with your family, Here is a
photo book where I've included photos of {Name1}, {Name2} and {Name3} and added
captions to each photo. Your family photo at the Big Ben was particularly good and so
I've picked it as a cover photo. You can always change the photos and captions before
deciding to print it.
Shows a photo book with editing and printing options.

Example 6:
User: “What photos did I take yesterday?”
System output: “Here are the photos that you took yesterday”
Shows a stack of all the photos taken by the user yesterday that they can
flick through and potentially share with other users.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A server with a processor to execute instructions to:
access user photo and video media via a network connection to a client machine;
analyze the user photo and video media to develop a user profile, where the user profile characterizes family relationships, friendship relationships, and interest relationships;
create a contextual store of user profiles, where the contextual store characterizes user demographics, identity, personality, interests and preferences;
send a query and user profile information to a network connected machine hosting a large language model; and
supply to the client machine a response to the query.

2. The server of claim 1 wherein the instructions executed by the processor access user media photo and video collections of a user associated with the client machine.

3. The server of claim 1 wherein the instructions executed by the processor access user media with privacy controls and permissions.

4. The server of claim 1 wherein the instructions executed by the processor analyze the user media to produce metadata for media items.

5. The server of claim 4 wherein the metadata includes temporal information, geolocation information, and device information.

6. The server of claim 1 wherein the instructions executed by the processor analyze the user media to classify entities as people, animals, places and objects.

7. The server of claim 1 wherein the instructions executed by the processor analyze the user media to produce face embeddings.

8. The server of claim 1 wherein the instructions executed by the processor analyze the user media to produce characterizations of user activities, relationships, experiences, interests, places visited, preferences, and habits.

9. The server of claim 1 wherein the contextual store of user profiles includes demographic information.

10. The server of claim 1 wherein the contextual store of user profiles includes personal interest information.

11. The server of claim 1 wherein the contextual store of user profiles includes lifestyle information.

12. The server of claim 1 wherein the contextual store of user profiles includes personal pattern information.

13. The server of claim 1 wherein the contextual store of user profiles includes psychological information.

14. The server of claim 1 further comprising a task performer to execute media related actions in response to a natural language request.

15. The server of claim 14 wherein the media related actions include creating a photo album.

16. The server of claim 14 wherein the media related actions include editing photographs in accordance with user preferences.

17. The server of claim 14 wherein the media related actions include creating personalized content summaries.
